(19) United States
(12) Patent Application Publication
(10) Pub. No.: US 2003/0101272 A1
(43) Pub. Date: May 29, 2003

(54) Data distribution control program and method thereof

(75) Inventors: Ryoichi Kaneko, Yokohama (JP); Kazuyoshi Suzuki, Yokohama (JP); Eiji Ujyo, Yokohama (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/102,830

(22) Filed: Mar. 22, 2002

(30) Foreign Application Priority Data
Nov. 27, 2001 (JP) 2001-361683

(51) Int. Cl. G06F 15/16

(52) U.S. Cl. 709/231

(57) ABSTRACT

When the distribution of distribution data is reserved, the band in use, distribution starting time and the like of the distribution data or already reserved distribution data are automatically modified depending on the type of the distribution method of additional distribution data, and a distribution schedule is adjusted.

### BACKGROUND OF THE INVENTION

1. Field of the Invention

The present invention relates to data distribution to devices connected by a communications line and relates a distribution control program for making a plurality of data distribution reservations for one or more other devices at a specific device and a method thereof.

2. Description of the Related Art

FIG. 1 shows the configuration of a conventional general data distribution system. A data management unit 11 obtains both distribution data 14 and distribution information 13 for distributing the data, for example, according to a user's instruction and notifies a communications control unit 12 of both the distribution data 14 and distribution information 13. The communications control unit 12 distributes the distribution data 14, based on the notified distribution information 13.

However, in such a distribution system, a transfer method (multicast/unicast), a band in use (transfer rate), a transfer mode (BEST_EFFORT/CONFIRM), the number of times of transmission and the like must be set for each piece of data as distribution information 13. Multicast is a method for transmitting the same data to a plurality of parties by designating a plurality of addresses, while unicast is a method for transmitting data to a specific party by designating a single address. When scheduling many pieces of distribution data, the setting of this distribution information 13 takes much time and is troublesome, which is a problem.

When scheduling a plurality of pieces of distribution data, both a distribution method, such as regular distribution/urgent distribution/recovery distribution and the like, which differs for each piece of data, and the operation conditions of receiving devices must also be taken into consideration.

Regular distribution, urgent distribution and recovery distribution mean distribution made at a predetermined time, distribution immediately made in response to a request issued irregularly and distribution made again to compensate for previous distribution when data are incorrectly distributed, respectively. For example, the terminal menu data of a receiving device are distributed using urgent distribution. BEST_EFFORT and CONFIRM are a communications method for guaranteeing service quality and a communications method for not guaranteeing service quality, respectively.

The adjustment of the distribution requests for a plurality of pieces of distribution data taking into consideration such distribution method and the operation conditions of a device requires a skilled operator and takes time.

Furthermore, when a schedule is adjusted and data are actually distributed, actual distribution sometimes finishes earlier than the scheduled completion time of the data distribution. In this case, in order to effectively use an idle time period until subsequent distribution, an operator must monitor distribution conditions day and night and must adjust a distribution schedule when there is an idle time period, which also involves personnel expenses.

Although there is also a possibility of modifying distribution information designated by a user, this modification is not compensated for.

### SUMMARY OF THE INVENTION

It is an object of the present invention to provide a distribution control program for efficiently adjusting the distribution schedule of a plurality of pieces of data in a distribution system for distributing data from a specific device to one or more other devices.

The distribution control program of the present invention distributes data to one or more devices. This distribution control program enables a computer to check the distribution method of given data, and to adjust a distribution schedule by modifying the distribution information of at least one piece of the given data and scheduled distribution data, depending on the type of the distribution method.

For example, in the case of regular distribution, a computer adjusts a distribution schedule by modifying the band in use of given distribution data. In the case of recovery distribution, a computer adjusts a distribution schedule by advancing the transmission time range of given distribution data. In the case of urgent distribution, a computer adjusts a distribution schedule by reducing the band in use of already scheduled distribution data.

According to such a distribution control program, when the distribution schedule of new data is added to an existing distribution schedule, proper schedule adjustment is automatically made depending on the type of the distribution method of the added data. Therefore, the distribution schedule of a plurality of pieces of data can be efficiently adjusted.

### BRIEF DESCRIPTION OF THE DRAWINGS

FIG. 1 shows the configuration of a conventional data distribution system;

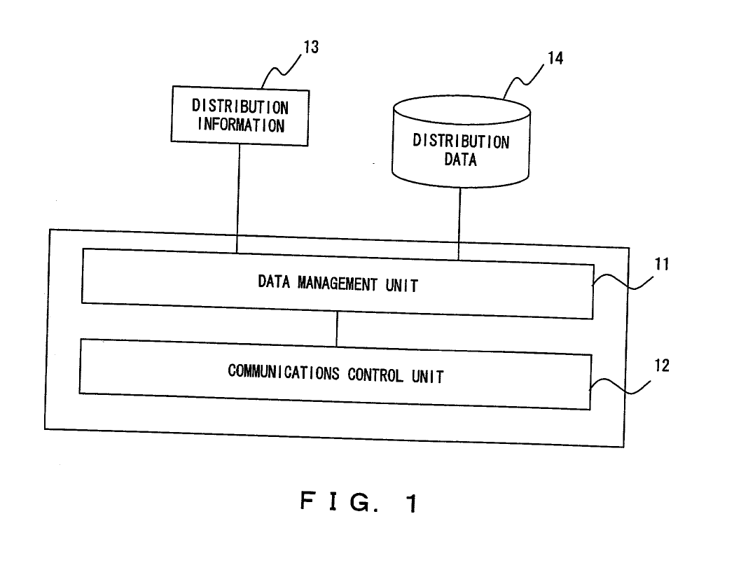

FIG. 2A shows the system configuration of multicast distribution;

FIG. 2B shows the configuration of the data distribution system of the present invention;

FIG. 3 shows the data structure of a channel management table;

FIG. 4 shows the data structure of a distribution management table;

FIG. 5 is a flowchart showing the regular distribution adjustment process;

FIG. 6 is a flowchart showing the recovery distribution adjustment process;

FIG. 7 shows a case where a transmission time range can be advanced;

FIG. 8 shows a case where a transmission time range cannot be advanced;

FIG. 9 is a flowchart showing the urgent distribution adjustment process;

FIG. 10 is a flowchart showing the advanced distribution adjustment process;

FIG. 11 is a flowchart showing the priority-based distribution adjustment process;

FIG. 12 shows a specific example of the channel management table;

FIG. 13 shows the first designated distribution information;

FIG. 14 shows the first distribution reservation information;

FIG. 15 shows the second distribution reservation information;

FIG. 16 shows the third distribution reservation information;

FIG. 17 shows the fourth distribution reservation information;

FIG. 18 shows modified distribution reservation information;

FIG. 19 shows the fifth distribution reservation information;

FIG. 20 shows the first adjustment result;

FIG. 21 shows the second designated distribution information;

FIG. 22 shows the second adjustment result;

FIG. 23 shows the configuration of the information processing device; and

FIG. 24 shows examples of storage media.

### DESCRIPTION OF THE PREFERRED EMBODIMENTS

The preferred embodiments are described in detail below with reference to the drawings.

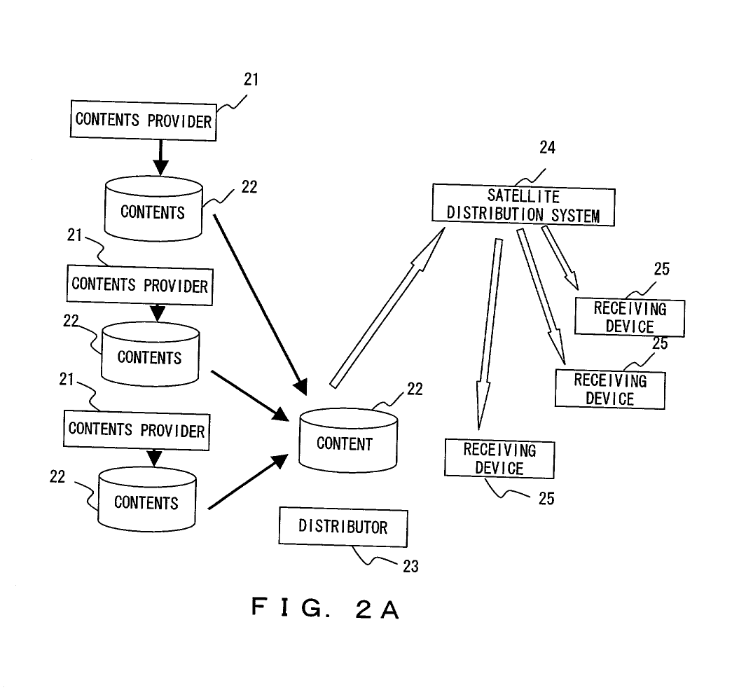

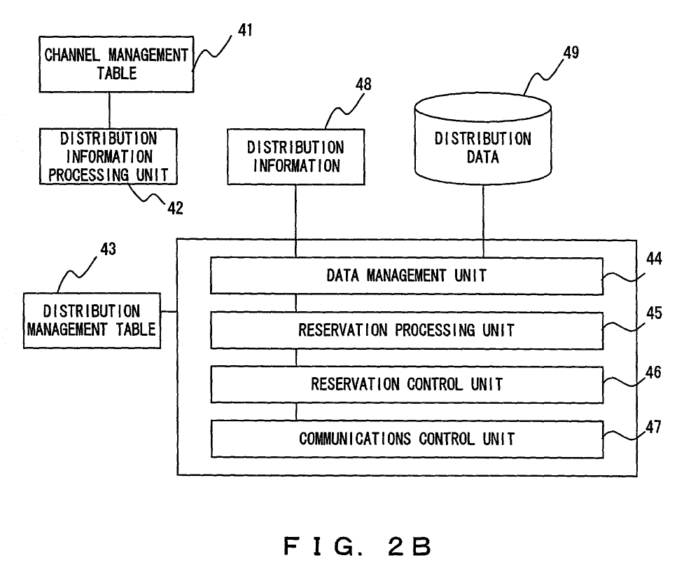

FIG. 2A shows the system configuration of multicast distribution using a satellite. In this example, a plurality of contents providers 21 transmit contents 22 to a distributor 23 which takes charge of data distribution. Upon receipt of the contents 22, the distributor 23 distributes data to a plurality of receiving devices 25 distributed across the country. A contents 22 includes data, such as text, images, pictures, voice and the like. For the receiving device 25, for example, a computer is used.

In this system, a plurality of channels are defined in order to divide an available band prior to data distribution. Distribution information is related to each channel. Therefore, a contents provider 21 can designate the distribution information of distribution data simply by designating a channel.

FIG. 2B shows the configuration of a distribution system used by a distributor 23. The distribution system shown in FIG. 2B is configured using a computer. The distribution system comprises a channel management table 41, a distribution information processing unit 42, a distribution management table 43, a data management unit 44, a reservation processing unit 45, a reservation control unit 46 and a communications control unit 47. The Distribution information processing unit 42, data management unit 44, reservation processing unit 45, reservation control unit 46 and the communications control unit 47 correspond to a program for enabling a computer to execute the process.

The channel management table 41 manages correspondence between a channel and distribution information, and the distribution management table 43 stores already reserved distribution information as distribution reservation information. The distribution information processing unit 42 obtains distribution information corresponding to a channel designated by a user (contents provider) from the channel management table 41. Then, the unit 42 determines the distribution information 48 of distribution data 49, based on the obtained distribution information, other designated distribution information and distribution reservation information obtained from the data management unit 44, and notifies the data management unit 44 of the distribution information 48.

Upon receipt of the distribution information 48 from the distribution information processing unit 42, the data management unit 44 notifies the reservation processing unit 45 of the distribution information 48 and designates the generation/update of the distribution management table 43. The unit 44 also obtains distribution reservation information from the reservation processing unit 45 and notifies the distribution information processing unit 42 of the distribution reservation information.

The reservation processing unit 45 generates/updates the distribution management table 43 designated by the data management unit 44, and manages the distribution management table 43. The unit 45 further notifies both the data management unit 44 and reservation control unit 46 of the distribution reservation information stored in the distribution management table 43.

If there is distribution reservation information to be distributed in the obtained distribution reservation information, the reservation control unit 46 notifies the communications control unit 47 of the distribution reservation information. Then, the communications control unit 47 distributes distribution data 49, based on the distribution reservation information obtained from the reservation control unit 46.

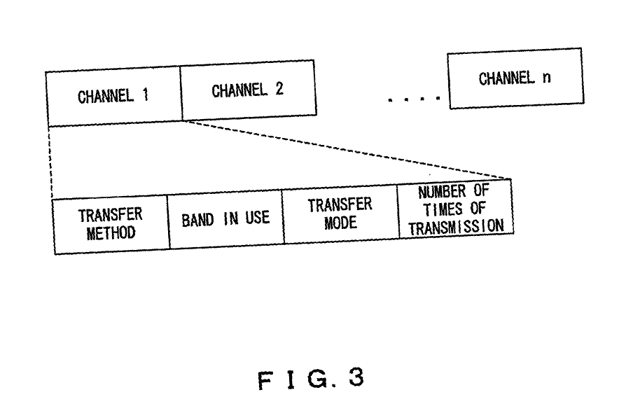

FIG. 3 shows the data structure of the channel management table 41. The channel management table 41 is composed of n available channel elements. Each element comprises a transfer method (multicast/unicast), a band in use (transfer rate), a transfer mode (BEST_EFFORT/CNFIRM) and the number of times of transmission.

If such a channel management table 41 is provided, a user can designate the distribution information of distribution data 49 simply by designating a channel and can make an efficient schedule.

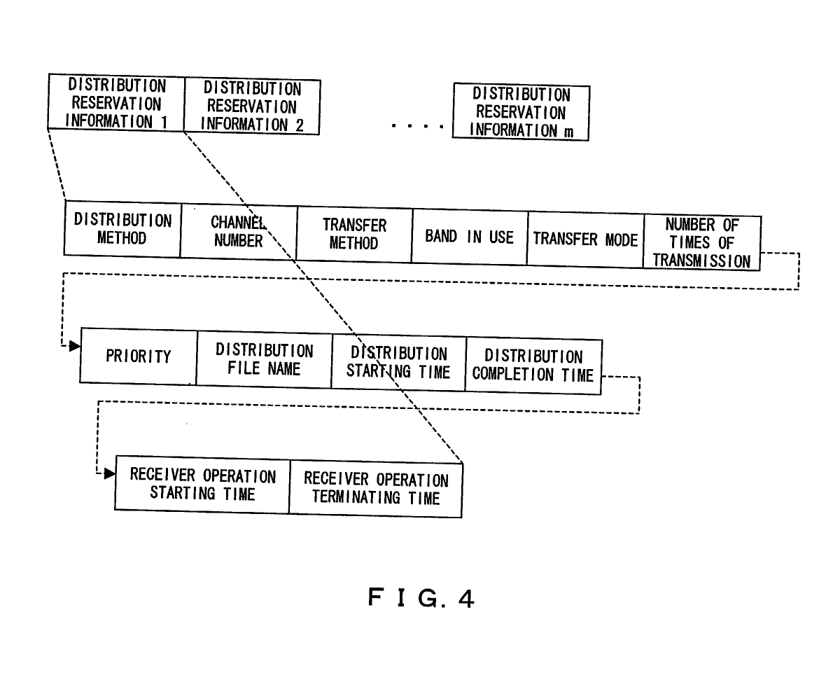

FIG. 4 shows the data structure of the distribution management table 43. The distribution management table 43 is composed of m pieces of distribution reservation information of reserved distribution data. Each piece of distribution reservation information comprises a distribution method (regular distribution/recovery distribution/urgent distribution), a channel number, a transfer method, a band in use, a transfer mode, the number of times of transmission, priority, a distribution file name, a distribution starting time, a distribution completion time, a receiver operation starting time and a receiver operation terminating time.

A channel number is the number of a designated channel, and priority is information indicating the priority order in distribution control of an item. In this case, a priority order is set in six items of a transfer system, a band in use, a transfer mode, the number of times of transmission, a distribution starting time and a distribution completion time. A distribution file name is the file name of distribution data 49, and receiver operation starting/terminating times correspond to the operation starting/terminating time of a receiving device 25.

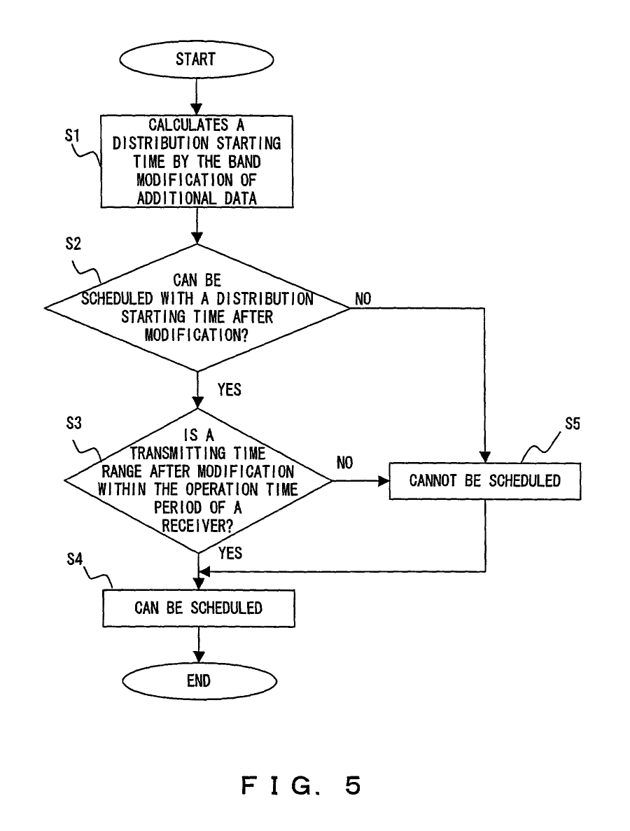

Next, the schedule adjustment algorithm of the distribution system shown in FIG. 2B is described with reference to FIGS. 5 through 11. According to this algorithm, an existing schedule is adjusted based on both the distribution method and the operation time range of a receiving device. In this case, the distribution information processing unit 42 checks the distribution method of additional distribution data and adjusts a distribution schedule depending on the type of the distribution method.

In the case of “regular distribution”, if distribution reservation information is added to the distribution management table 43, the schedule of the additional data sometimes overlaps an existing schedule. In such a case, the distribution information processing unit 42 adjusts the schedule by performing a regular distribution adjustment process shown in FIG. 5.

In the case of “regular distribution”, designated data sometimes must be transmitted strictly at a predetermined time. Specifically, the distribution completion time must not be modified. In such an adjustment process, the schedule is adjusted in such a way that distribution reservation information can be added by modifying the distribution starting time without modifying the distribution completion time of distribution data.

The distribution information processing unit 42 first calculates a modified distribution starting time by modifying the band in use of additional data (step S1). Then, the unit 42 checks whether the additional data can be scheduled using the calculated distribution starting time (step S2). If the additional data cannot be scheduled in this stage, the distribution reservation information of the data cannot be added, the unit 42 notifies a user of the fact (step S5).

If the additional data can be scheduled, then the unit 42 checks whether a transmission time range after modification is included in the operation time range (step S3). A transmission time range is a time range from the distribution starting time until the distribution completion time that are shown in FIG. 4, and the operation time range of a receiving device is a time range from the receiver operation starting time until the receiver operation terminating time that are shown in FIG. 4. If a transmission time range after modification is not included in the operation time range, the additional data cannot be scheduled, and a process in step S5 is performed. If a transmission time range after modification is included in the operation time range, it is determined that the additional data can be scheduled and the schedule is adjusted (step S4).

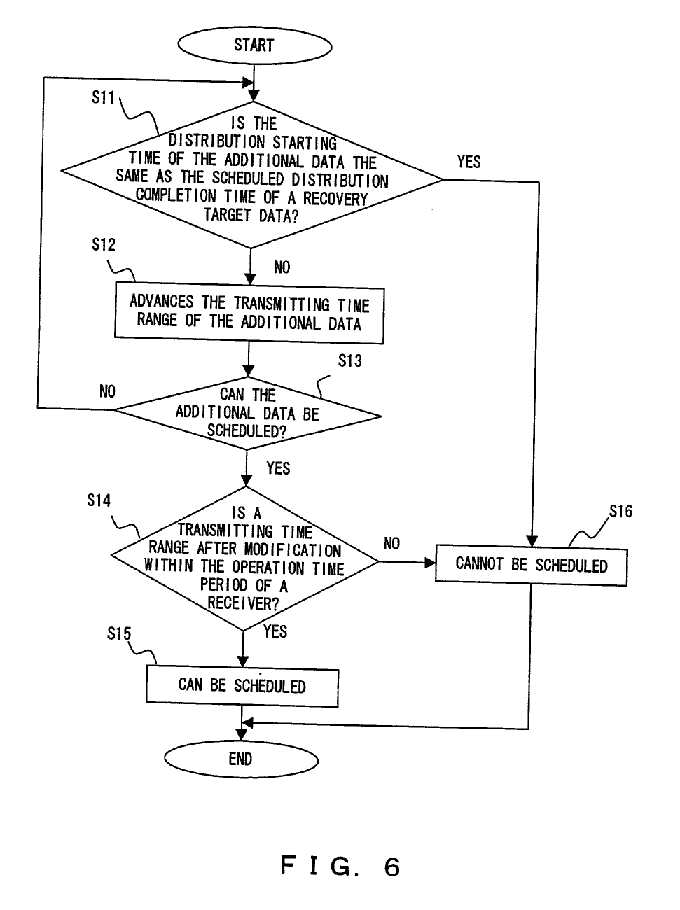

In the case of “recovery distribution”, the schedule of the additional data sometimes overlaps an existing schedule. In such a case, the distribution information processing unit 42 adjusts the schedule by making the recovery distribution adjustment shown in FIG. 6.

In the case of “recovery distribution”, if the distribution of the relevant recovery target distribution data has been completed, a transmission time range can be shifted. In such adjustment, a schedule can be adjusted in such a way that distribution reservation information can be added, by modifying the transmission time range of distribution data.

The distribution information processing unit 42 first checks whether the distribution starting time of additional data is the same as the scheduled distribution completion time of the relevant recovery target distribution data (step S11). If the distribution starting time of additional data is earlier than the scheduled distribution completion time of the recovery target data, the additional data cannot be scheduled in this stage and the unit 42 notifies a user of the fact (step S16).

If the distribution starting time of additional data is later than the scheduled distribution completion time of the recovery target data, the transmission time range of the additional data is advanced by a specific time period (step S12). Then, the unit 42 checks whether the additional data can be scheduled (step S13). In this case, it is checked whether the transmission time range after modification overlaps another existing schedule. If the additional data cannot be scheduled, processes in and after step S11 are repeated.

In this way, the advanced earlier distribution starting time is compared with the scheduled distribution completion time of the recovery target data. If the distribution starting time does not reach the scheduled distribution completion time, the transmission time range is further advanced and it is checked whether the additional data can be scheduled.

If in step S13 the additional data can be scheduled, the unit 42 checks whether the transmission time range after modification is within the operation time range of a receiving device (step S14). If the transmission time range after modification is not within the operation time range of a receiving device, the additional data cannot be scheduled and a process in step S16 is performed. If the transmission time range after modification is within the operation time range of a receiving device, it is determined that the additional data can be scheduled and the schedule is adjusted (step S15).

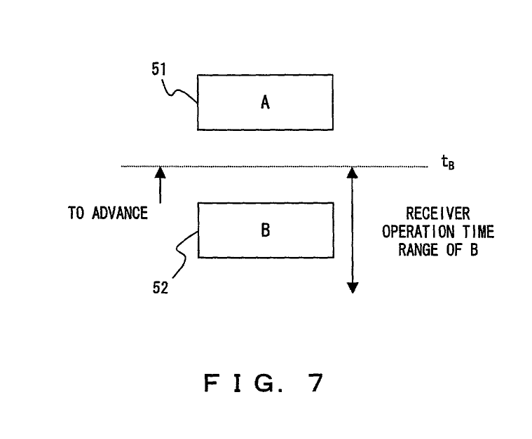

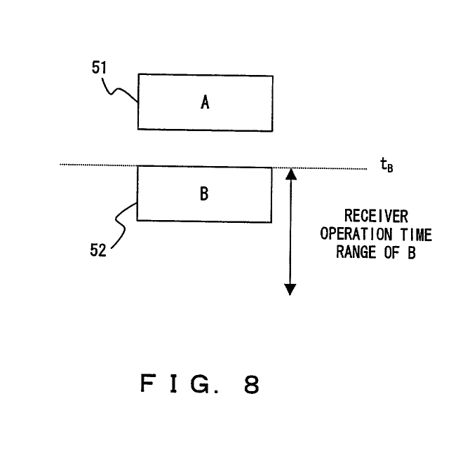

For example, as shown in FIG. 7, if there is an idle time between the transmission time range 51 of distribution data A and the transmission time range 52 of distribution data B and if the distribution starting time of additional data B is later than the receiver operation starting time t_{B}, the transmission time range 52 can be advanced and additional data B can be scheduled. However, as shown in FIG. 8, if the distribution starting time of additional data B is the same as the receiver operation starting time t_{B}, the transmission time range 52 cannot be advanced.

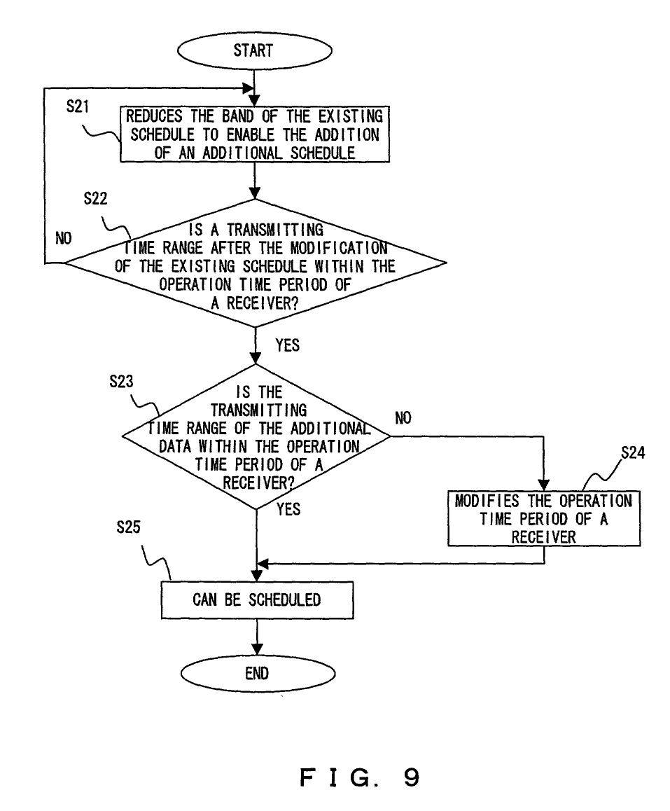

Furthermore, if the distribution method of additional distribution data is “urgent distribution”, the schedule of the data sometimes overlaps an existing schedule. In such a case, the distribution information processing unit 42 adjusts the schedule by making the urgent distribution adjustment process shown in FIG. 9.

In the case of “urgent distribution”, the schedule must be adjusted by modifying another schedule without modifying the additional distribution schedule. In such adjustment, the schedule can be adjusted in such a way that distribution reservation information can be added, by modifying the band in use of an existing schedule or modifying the receiver operation time range of the additional data.

The distribution information processing unit 42 first reduces the band in use of an existing schedule in order to enable the addition of an additional schedule (step S21). Then, the unit 42 checks whether the transmission time range of the existing schedule modified by this modification is within the operation time range of a receiving device (step S22). If the transmission time range of the existing schedule modified by this modification is not within the receiver operation time range, a process in step S21 is repeated until the additional schedule can be scheduled.

If the transmission time range is within the receiver operation time range and the adjustment of an existing schedule is completed, then it is checked whether the transmission time range of additional data is within the operation time range of a receiving device (step S23). If the transmission time range is not within the operation time range, the receiver operation time range is modified in such a way that the additional data can be scheduled (step S24). If the additional data can be scheduled, the schedule is adjusted (step S25). If in step S23 the transmission time range is within the operation time range, the process in step S25 is performed without performing any other process.

According to the schedule adjustment processes described in FIGS. 5, 6 and 9, the schedule can be efficiently adjusted based on both the distribution method of distribution data and the operation time range of a receiving device.

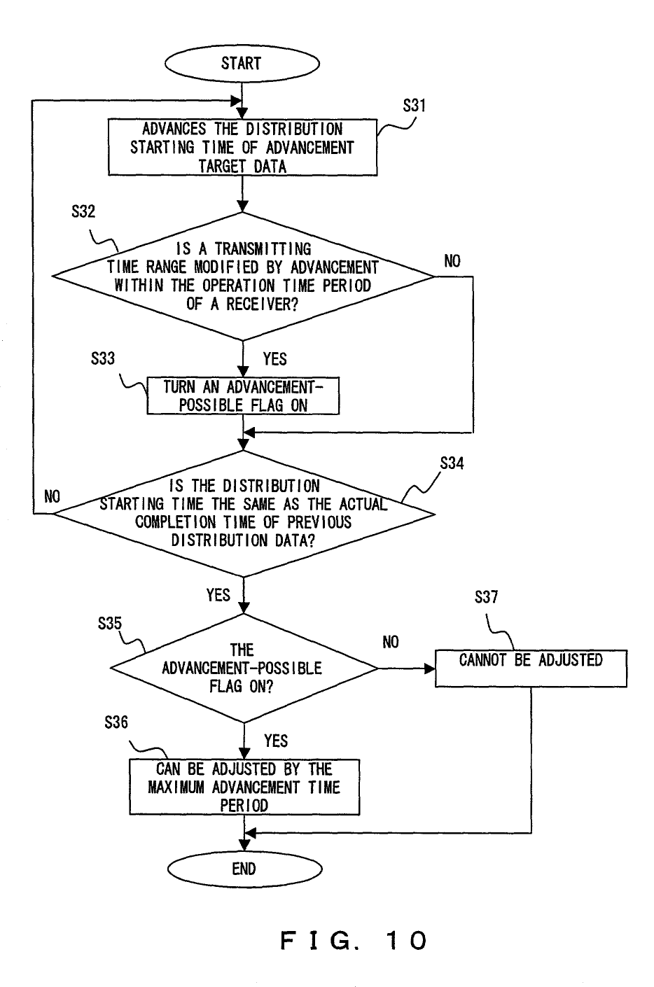

Then, a case is studied where in a distribution schedule, another distribution to be performed in succession when a specific distribution is completed is reserved. In this case, if an actual transmission time period is shorter than the anticipated transmission time period of previous distribution data, there is a possibility of advancing the transmission time range of subsequent distribution data. In this case, the distribution information processing unit 42 adjusts the schedule by making the advancement distribution adjustment shown in FIG. 10. It is assumed that in an initial state, an advancement-possible flag is set off.

The distribution information processing unit 42 first advances the distribution starting time of target data by a specific time period (step S31), and checks whether the transmission time range modified by this advancement is within the operation time range of a receiving device (step S32).

If the transmission time range is within the operation time range, the unit 42 sets an advancement-possible flag on (step S33), and checks whether the modified distribution starting time is the same as the actual distribution completion time of previous distribution data (step S34). If the transmission time range is not within the operation time range, the process in step S33 is skipped and processes in and after step S34 are performed.

If the distribution starting time does not reach the distribution completion time of previous distribution data, the processes in and after step S31 are repeated in order to check whether further advancement is possible. If in step S34 the distribution starting time range reaches the distribution completion time of the previous distribution data, the unit 42 checks whether an advancement-possible flag is on (step S35).

If this flag is off, the schedule cannot be adjusted since the transmission time range cannot be advanced (step S37). If the flag is on, the unit 42 advances the maximum possible advancement time period and adjusts the schedule (step S36).

In this case, the relation between previous distribution and target data is the same as the relation between distribution data A and distribution data B shown in FIGS. 7 and 8. According such schedule adjustment, if actual distribution finishes earlier than the scheduled distribution completion time, an idle time period until subsequent distribution can be effectively used.

Although the description given above has not mentioned, in this preferred embodiment, a user designates the priority of items included in distribution information for each piece of distribution data, and distribution information processing unit 42 adjusts the schedule by modifying the values of the items in ascending order of the priority. As described above, priority is given to six items of a transfer method, a band in use, a transfer mode, the number of times of transmission, a distribution starting time and a distribution completion time.

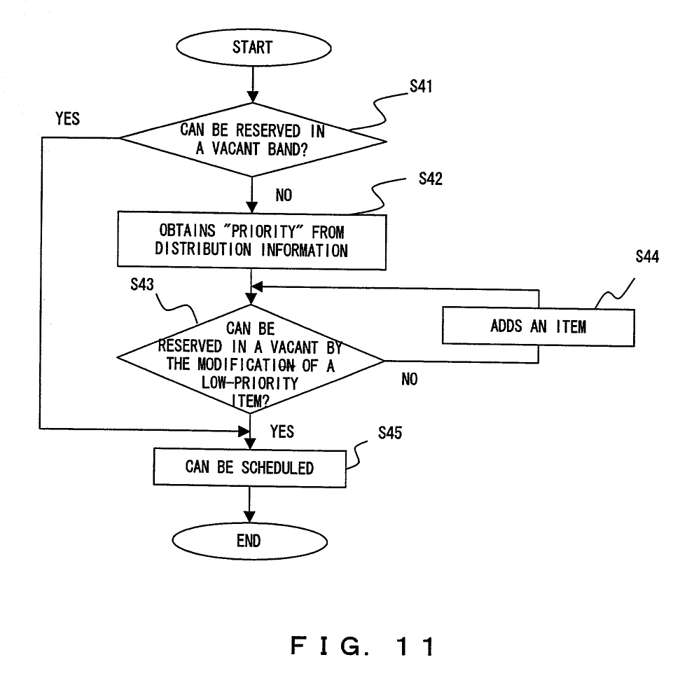

FIG. 11 is a flowchart showing such an adjustment process based on priority. The distribution information processing unit 42 first checks whether the schedule of additional data can be reserved in a vacant band without overlapping the existing schedule (step S41) If the schedule of additional data can be reserved, the schedule is determined as it is, and the unit 42 adjusts the schedule (step s$5).

If the schedule of additional data cannot be reserved in a vacant band, the unit 42 obtains the priority of items in the distribution information designated by a user (step S42) and checks whether the schedule can be reserved by modifying the value of an item in ascending order of the priority (step S43). If the schedule cannot be reserved by modifying the value of a specific item, an item with the then second lowest priority is added as a variable item until the schedule can be reserved (step S44), and processes in and after S43 are repeated. In this way, it is checked whether the schedule can be reserved, by modifying the values of a plurality of items. When the schedule can be reserved, a process in step S45 is performed.

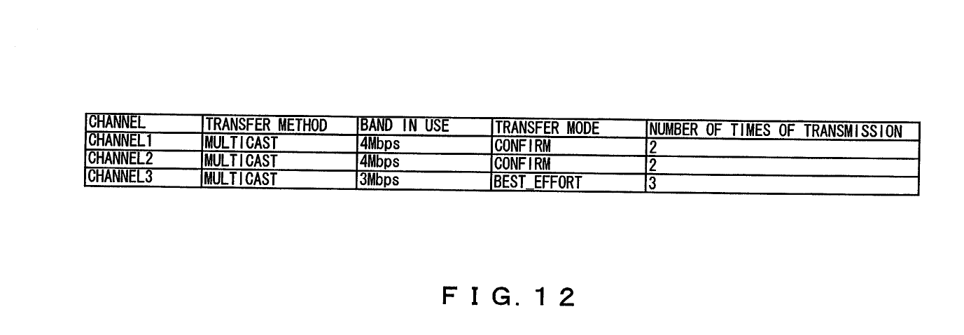

Next, specific examples of the schedule adjustment are described in detail with reference to FIGS. 12 through 22.

As shown in FIG. 2A, a plurality of contents providers transmit a variety of contents 22 to a distributor 23. The distribution request of each contents varies, and the distributor 23 makes a distribution schedule so as to satisfy each request and distributes data.

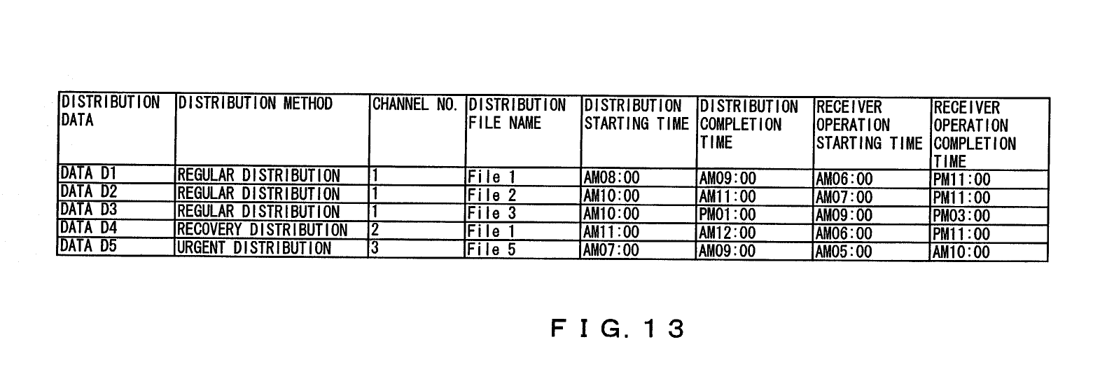

It is assumed that the channel management table 41 stores, for example, three channels shown in FIG. 12. It is also assumed that the current time is 7:00 am as a distribution environment and the available band of a satellite used for distribution is 6 Mbps. A case is studied where the distributor 23 receives distribution requests for five pieces of distribution data D1-D5 shown in FIG. 13 from a plurality of contents providers 21 (users) and sequentially schedules these requests.

In this case, each user can efficiently designate distribution information simply by designating a channel number without designating a transfer method and the like for each piece of distribution data. Although the distribution information shown in FIG. 13 omits priority, in realty each user designates priority for each piece of distribution data.

Firstly, since the schedules of data D1 and D2 do not overlap an existing reservation schedule, the two pieces of data can be scheduled as designated. The distribution information of each of the two pieces of data is notified to a reservation processing unit 45 through the data management unit 44. The reservation processing unit 45 generates distribution reservation information of each piece of data D1 and D2.

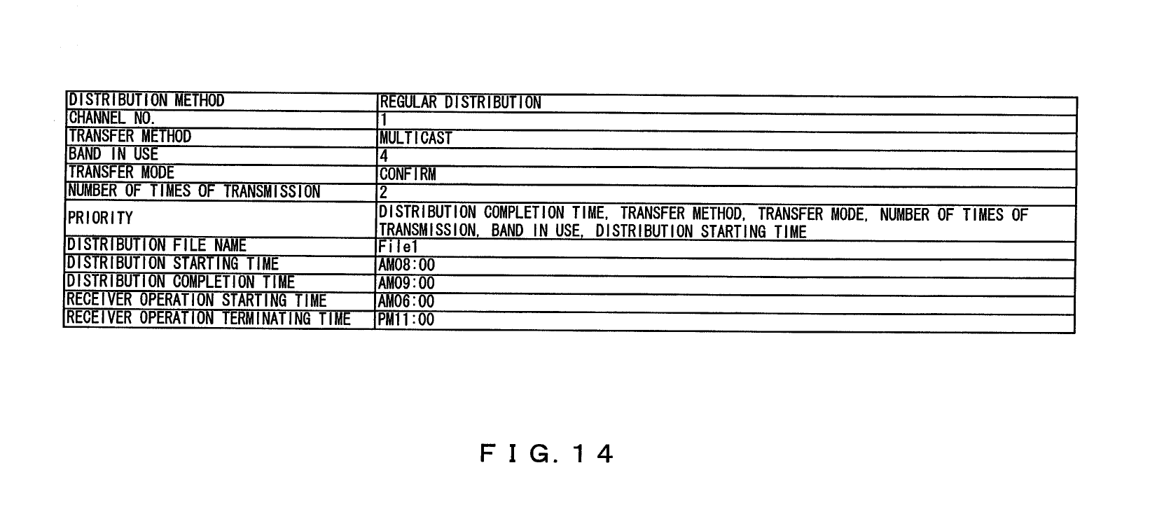

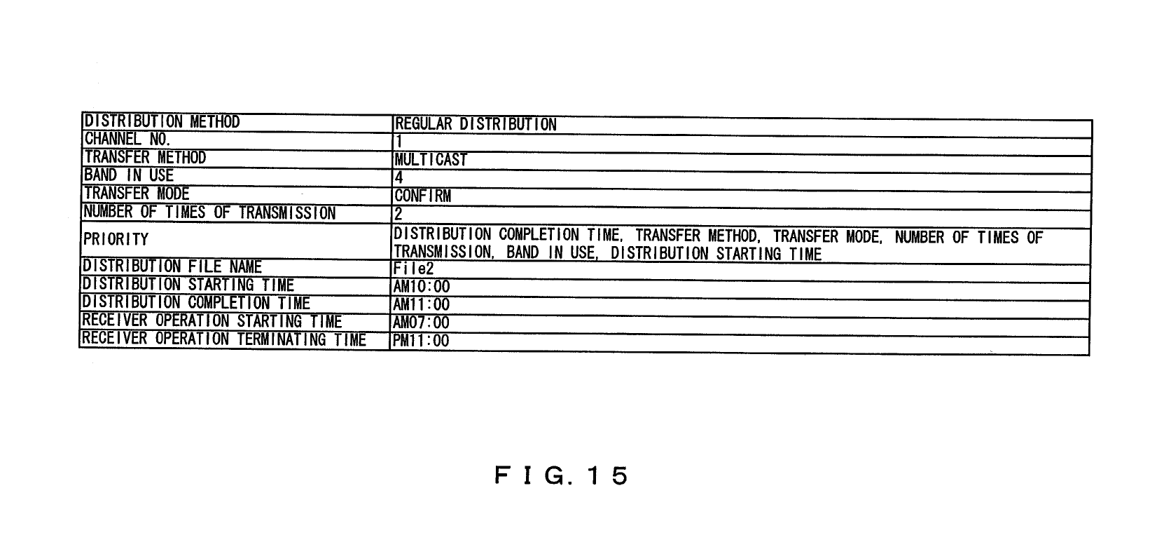

When data D1 are scheduled, distribution reservation information as shown in FIG. 14 is registered in the distribution management table 43. However, when data D2 are scheduled, distribution reservation information as shown in FIG. 15 is registered in addition to the distribution reservation information of data D1.

Next, the addition of the distribution reservation of data D3 is studied. In this case, it is detected from the existing distribution reservation information obtained from the data management unit 44 (FIGS. 14 and 15) that since the schedule of data D3 overlaps the schedule of data D2, data D3 data cannot be scheduled without some modification. Since the distribution method of data D3 is “regular distribution”, the schedule is adjusted by the process shown in FIG. 5.

First, the distribution information processing unit 42 modifies the distribution starting time of data D3 from 10:00 am to 11:00 am by modifying the band in use of data D3 from 4 Mbps to 6 Mbps. In this case, since a transmission time range after modification (from 11:00 and 1:00 pm) is between the operation starting time of a receiving device (9:00 am) and the operation terminating time (3:00 pm), data D3 can be scheduled using the distribution starting time after modification.

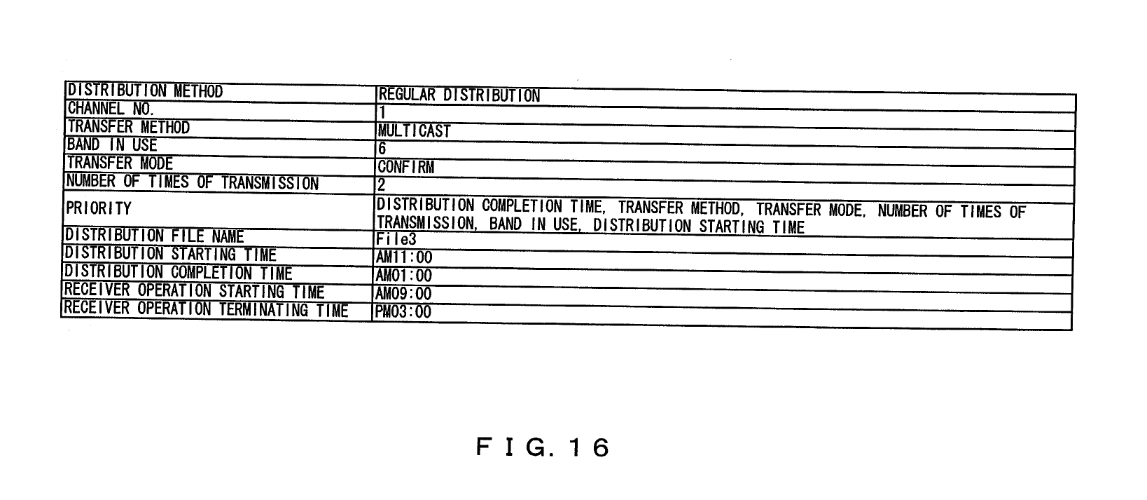

Then, the modified distribution information of data D3 is notified to the reservation processing unit 45 through the data management unit 44. The reservation processing unit 45 generates distribution reservation information shown in FIG. 16 in the distribution management table 43.

Next, the addition of the distribution reservation information of data D4 is studied. It is detected from both the distribution information of data D4 and the existing distribution reservation information obtained from the data management unit 44 (FIGS. 14, 15 and 16) that since the schedule of data D4 overlaps the schedule of data D3, data D4 cannot be scheduled without some modification. Since the distribution method of data D4 is “recovery distribution”, the schedule is adjusted by the process shown on FIG. 6.

In this example, the recovery target of the distribution data is data D1, and the distribution starting time of data D4 (11:00 am) is different from the scheduled distribution completion time of data D1 (9:00 am). Therefore, the distribution information processing unit 42 checks whether data D4 can be scheduled by advancing the transmission time range of data D4 step by step.

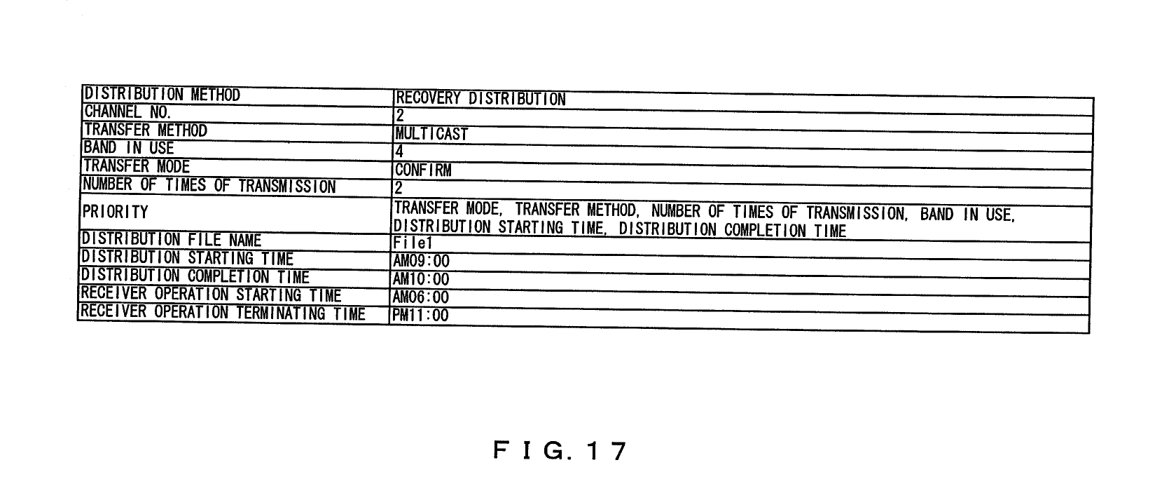

Even if the distribution starting time of data D4 is advanced up to the scheduled distribution completion time (9:00 am), a transmission time range after modification obtained by advancement is between the operation time range of a receiving device and the operation terminating time (11.00 pm). Therefore, data D4 can be scheduled. Then, the modified distribution information of data D4 is notified to the reservation processing unit 45 through the data management unit 44. The reservation processing unit 45 generates distribution reservation information shown in FIG. 17 in the distribution management table 43.

Next, the addition of the distribution reservation information of data D5 is studied. It is detected from both the distribution information of data D5 and the existing distribution reservation information obtained from the data management unit 44 (FIGS. 14, 15, 16 and 17) that since the schedule of data D5 overlaps the schedule of data D1, data D5 cannot be scheduled without some modification. Since the distribution method of the data D4 is “urgent distribution”, the schedule is adjusted by the process shown on FIG. 9.

First, the distribution information processing unit 42 checks whether data D5 can be schedule by reducing the band in use of data D1, the schedule of which overlaps the schedule of data D5. Then, it is detected that the band in use can be reduced from 4 Mbps to 2 Mbps by modifying the distribution starting time of data D1 from 8:00 am to 7:00 am.

By this band reduction, the modified transmission time range of data 1 (from 7:00 am and 9:00 am) is included in the operation time range of a receiving device (from 6:00 am to 11:00 pm) and the transmission time range of the urgent distribution data D5 is also included in the operation time range of a receiving device (from 6:00 am to 11:00 pm). Therefore, data D5 can be scheduled.

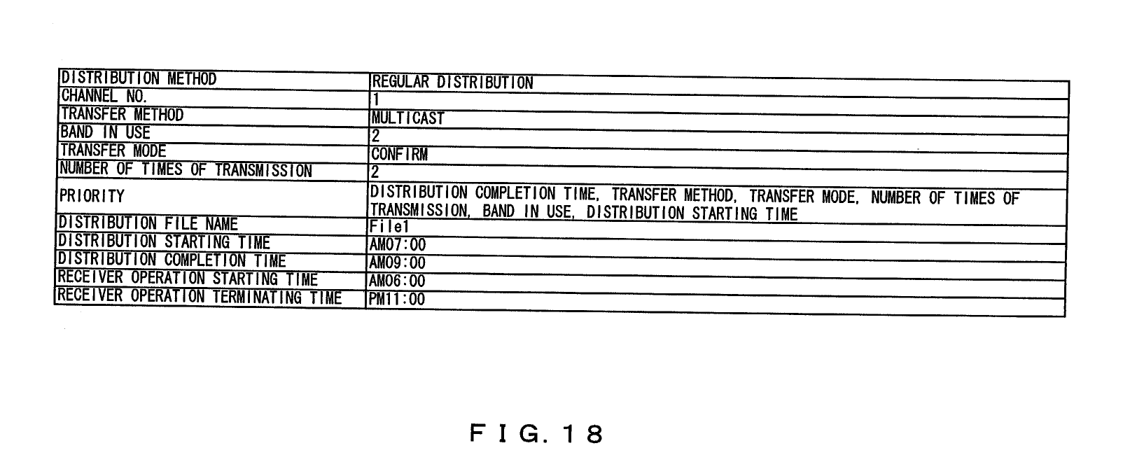

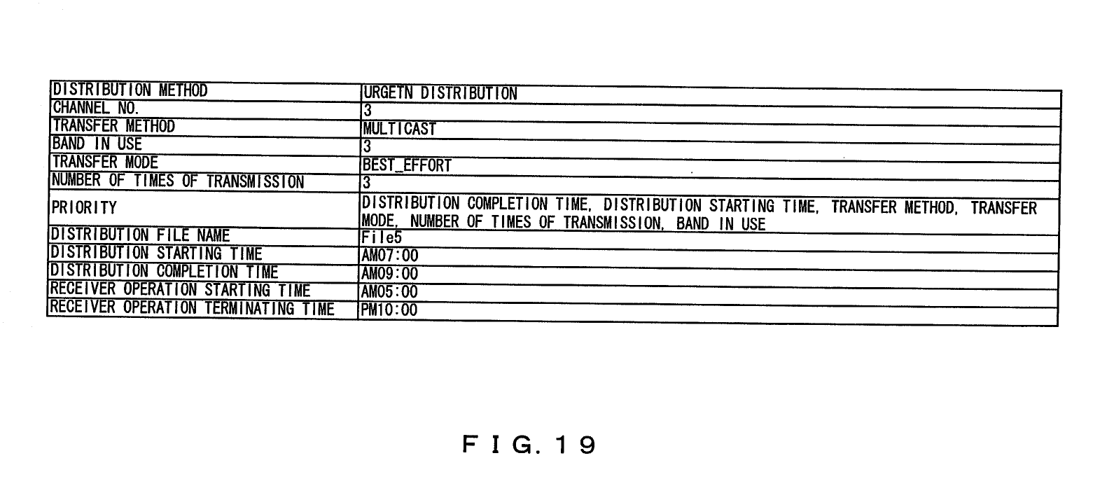

Then, both the distribution information of data D5 and the modified distribution information of data D1 are notified to the reservation processing unit 45 through the data management unit 44. The reservation processing unit 45 modifies the distribution reservation shown in FIG. 14 as shown in FIG. 18, and also generates distribution reservation information of data D5 shown in FIG. 19.

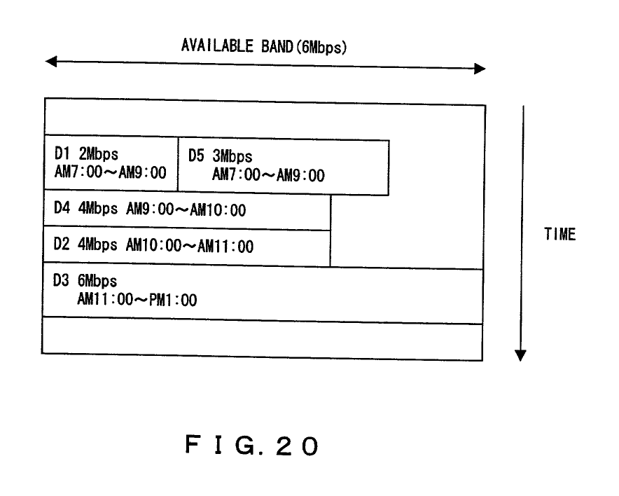

In this way, the schedule of the distribution data shown in FIG. 13 is adjusted as shown in FIG. 20. FIG. 20 shows the bands in use of each piece of data after adjustment.

In this example it is assumed that, for example, data D3 are scheduled to be distributed at the same time the distribution of data D2 is completed. In this case, the actual transmission time period of data D2 that are distributed immediately before data D3 is half an hour and is shorter than the anticipated transmission time period (one hour), data D3 are advanced and distributed by the process shown in FIG. 10.

First, the distribution processing unit 42 continues to advance the distribution starting time (11:00 am) of data D3, which is an advancement target, toward the actual distribution completion time of data D2 (10:30 am). In this case, a transmission time range (from 9:00 am to 3:00 pm) obtained when the distribution starting time is advanced by the maximum possible advancement time period (half an hour) is within the operation time range of a receiving device (from 9:00 am to 3:00), and the data distribution of data D3 can be scheduled. Therefore, the schedule can be adjusted using this advancement time period.

Then, the modified distribution information of data D3 is notified to the reservation processing unit 45 through the data management unit 44. The reservation processing unit 45 modifies the distribution reservation information of data D3 shown in FIG. 16 and updates the distribution management table 43. A communications control unit 47 obtains distribution reservation information from the modified distribution management table 43 through a reservation control unit 46 and distributes data according to the information. In this case, as a result, the half an hour can be effectively used for another distribution.

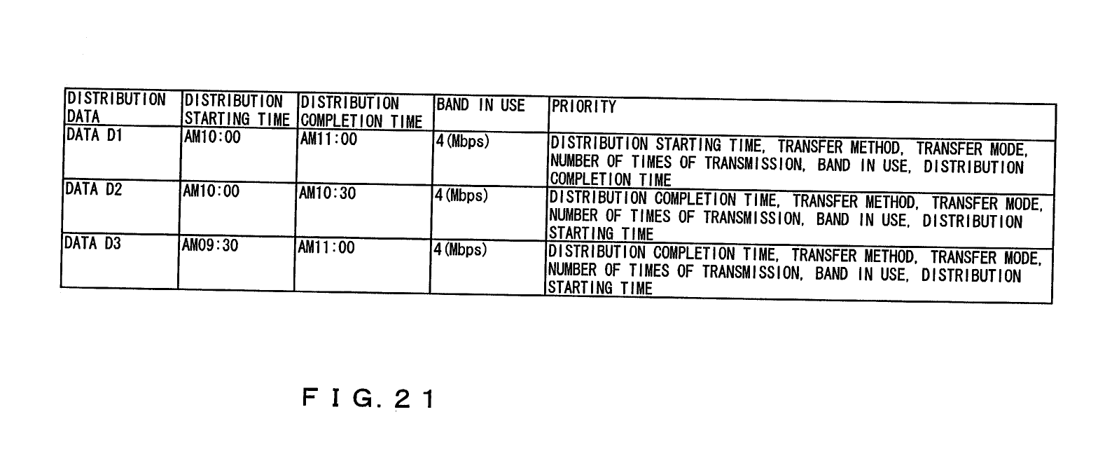

Next, a case is studied where distribution requests for three pieces of distribution data D1-D3 shown in FIG. 21 are received and these requests are sequentially scheduled by the process shown in FIG. 11. However, it is assumed that the current time is 7:00 am and an available band is 6 Mbps. Six items are recorded in descending order of priority in the column of distribution information priority.

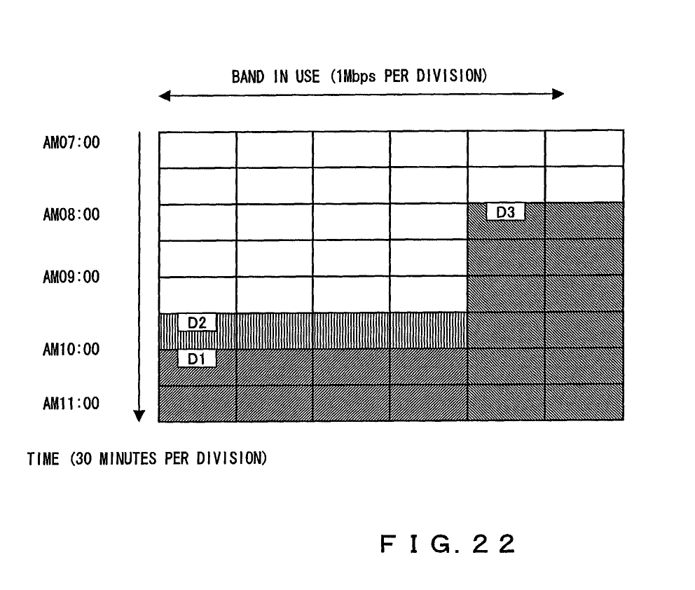

First, data D1 is judged to be able to be reserved, based on designated distribution information, as shown in FIG. 22, and the distribution reservation information is registered in the distribution management table 43. Then, the band in use of already reserved data D1 and the band in use of data D2 are compared and it is checked whether data 2 can be reserved in a vacant band. In this example, since the transmission time ranges of data D1 and D2 are partially overlapped and a vacant band (2 Mbps) is narrower than the band in use of data D2, data 2 cannot be reserved.

Therefore, priority information is obtained from the distribution information of data D2. In this example, since an item with the lowest priority is a “distribution starting time”, it is checked whether data D2 can be reserved in a vacant band by modifying the distribution starting time of data D2. As a result, as shown in FIG. 22, data D2 can be reserved by modifying the starting time from 10:00 am to 9:30 am.

Lastly, the distribution of data D3 is reserved. First, the bands in use of already reserved data D1/D2 and the band in used of data D3 are compared and it is checked whether data D3 can be reserved in a vacant band. In this example, the transmission time range of data D3 overlap the transmission time ranges of data D1/D2 and a vacant band (2 Mbps) is narrower than the band in use of data D3, data D3 cannot be reserved.

Therefore, priority information is obtained from the distribution information of data D3. Since an item with the lowest priority is a “distribution starting time”, it is checked whether data D3 can be reserved in a vacant band by modifying the distribution starting time of data D3. However, since data D3 cannot be reserved even by modifying the starting time, it is checked whether data D3 can be reserved by modifying a “band in use” with the then second lowest priority in addition to the “distribution starting time”. As a result, as shown in FIG. 22, data D3 can be reserved by modifying the starting time from 9:30 am to 8:00 am and also modifying the band in use from 4 Mbps to 2 Mbps.

In the schedule adjustment described above, since a part of the distribution information designated by a user is modified, it is necessary to notify the user of information for compensating for the modification. Therefore, the distribution information processing unit 42 calculates the difference in modified distribution information between before and after schedule adjustment as compensation information for a user, and the communications control unit 47 notifies the user of the information. A process is described below where the difference of both a band in use and a distribution starting time of a plurality of items in distribution information are notified.

The distribution processing unit 42 first calculates a numeric value obtained by attaching prescribed signs to the absolute values of modification amounts before and after the schedule adjustment of each of a band in use and a distribution starting time.

In the case of a band in use, the difference in band between before and after adjustment is taken as an absolute value and if the band is increased, a negative sign (−) is attached. If the band is reduced, a positive sign is attached. Since the increase of a band in use is a user's advantage and the compensation is negative, a negative sign is attached. Conversely, since the reduction of a band in use is a user's disadvantage and the compensation is positive, a positive sign (+) is attached.

In the case of a distribution completion time, the difference in scheduled completion time between before and after adjustment is taken as an absolute value and if time is delayed, a positive sign is attached. If time is advanced, a negative sign is attached. Since the delay of a distribution completion time is a user's disadvantage and the compensation is positive, a positive sign is attached. Conversely, since the advancement f a distribution starting time is a user's advantage and the compensation is negative, a negative sign is attached.

Then, each of these two numeric values is weighted and the sum of the two weighted values is calculated as a compensatory numeric value.

For example, it is assumed that in distribution information designated by a user in the first place, a band in use and a distribution completion time are 4 Mbps and 3:00 pm, respectively. It is also assumed that by the adjustment of a distribution schedule, the band in use and distribution completion time are modified to 2 Mbps and 2:00 pm, respectively.

In this example, the band in use is reduced by 2 Mbps (=4−2) in units of Mbps. Therefore, a numeric value representing the modification of the band in use becomes +2. The distribution completion time is advanced by 1 (=3−1) in units of hours. Therefore, a numeric value for representing the modification of the distribution completion time becomes −1.

If the respective weights of a band in use and distribution completion time are assumed to be as 2 and 1, respectively, these two numeric values are weighted and the results are summed, the following result is obtained.

2×(+2)+1×)−1)=3

The numeric value (3) calculated in this way is notified to a user as a compensatory numeric value. Alternatively, a corresponding compensatory amount can also be calculated using this numeric value and the compensatory amount can also be deducted from a user's charge amount before adjustment. In this way, a user can obtain both charging information and proper compensation for the designated modification of distribution information.

Although in this example, a compensatory numeric value is calculated based on the modification amounts of both a band in use and a distribution completion time, this value can also be calculated based on only one of the amounts.

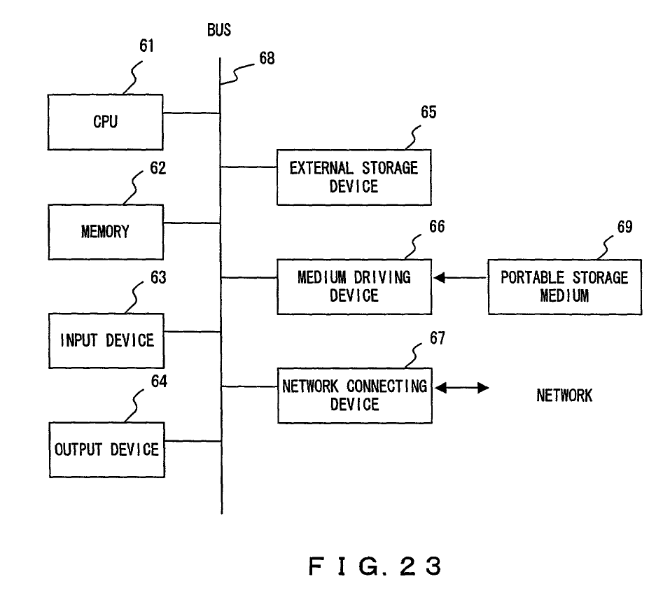

The data distribution system shown in FIG. 2 can be configured using an information processing unit (computer), for example, as shown in FIG. 23. The information processing unit shown in FIG. 23 comprises a CPU (central processing unit) 61, a memory 62, an input device 63, an output device 64, an external storage device 65, a medium driving device 66 and a network connecting device 67, and the units and devices are connected to each other by a bus 68.

For the memory 62, for example, a ROM (read-only memory), a RAM (random-access memory) and the like are used. The memory 62 stores both programs and data used for the process. The CPU 61 performs necessary processes by using the memory 62 and executing the programs. The channel management table 41, distribution management table 43 and distribution information that are shown in FIG. 2B correspond to data stored in the memory 62. The distribution information processing unit 42, the data management unit 44, reservation processing unit 45, reservation control unit 46 and communications control unit 47 correspond to the programs stored in the memory 62.

For the input device 63, for example, a keyboard, a pointing device, a touch panel and the like are used. The input device 63 is used to input operator's instructions and information. For the output device 64, for example, a display, a printer, a speaker and the like are used. The output device 64 is used to output inquiries to an operator and process results.

For the external storage device 65, for example, a magnetic disk device, an optical disk device, a magneto-optical disk device, a tape device and the like are used. The information processing device stores in advance both the programs and data described above in this external storage device 65, and uses the programs and data by loading the programs and data onto the memory 62, if requested. The distribution data shown in FIG. 2B are also stored in the external storage device 65.

The medium driving device 66 drives a portable storage medium 69 and accesses the recorded contents. For the portable storage medium 69, an arbitrary computer-readable storage medium, such as a memory card, a flexible disk, a CD-ROM (compact disk read-only memory), an optical disk, a magneto-optical disk and the like, is used. The operator stores in advance the programs and data described above in this portable storage medium 69 and uses the programs and data by loading the programs and data on to the memory 62, if requested.

The network connecting device 67 is connected to an arbitrary communications network, such as a LAN (local area network), the Internet and the like, and exchanges data accompanying communications. The information processing unit receives the programs and data described above from another device through the network connecting device 67 and uses the programs and data by loading the programs and data on to the memory 62, if requested.

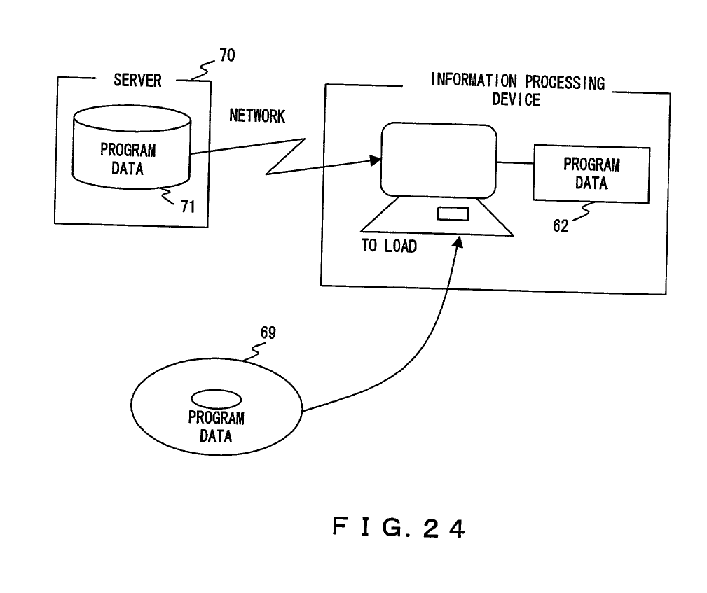

FIG. 24 shows examples of a computer-readable storage medium for supplying the information processing unit shown in FIG. 23 with programs and data. The programs and data stored in the portable storage medium 69 or the database 71 of a server 70 are loaded onto the memory 62. In this case, the server 70 generates a carrier signal for carrying the programs and data, and transmits the programs and data to the information processing device through an arbitrary transmission medium in a network. Then, the CPU 61 performs necessary processes by using the data and executing the programs.

According to the present invention, when a specific device distributes a plurality of pieces of data to one or more other devices, the distribution schedules of the plurality of pieces of data can be efficiently adjusted.

What is claimed is:

1. A computer-readable storage medium which stores a distribution control program for enabling a computer to distribute data to one or more devices, the process comprising:
checking a distribution method of given distribution data; and
modifying distribution information of at least one of the given distribution data and scheduled distribution data depending on a type of the distribution method, and adjusting a distribution schedule.

2. The storage medium according to claim 1, wherein the computer adjusts the distribution schedule in such a way that a transmission time range of each piece of the given distribution data and scheduled distribution data can be included in an operation time range of a receiving device in the adjustment of the distribution schedule.

3. The storage medium according to claim 1, wherein if the type of the distribution method is regular distribution, the computer modifies a band in use of the given distribution data in the adjustment of the distribution schedule.

4. The storage medium according to claim 1, wherein if the type of the distribution method is recovery distribution, the computer advances the transmission time range of the given distribution data in the adjustment of the distribution schedule.

5. The storage medium according to claim 1, wherein if the type of the distribution method is urgent distribution, the computer reduces the band in use of the scheduled distribution data in the adjustment of the distribution schedule.

6. The storage medium according to claim 1, wherein the distribution control program further enables the computer to advance the transmission time range of the given distribution data if an actual transmission time period of distribution data immediately before the given distribution data is shorter than a scheduled transmission time period.

7. The storage medium according to claim 1, wherein the computer determines an item to be modified according to priority of a plurality of items of distribution information designated by a user in the adjustment of the distribution schedule.

8. The storage medium according to claim 1, wherein the distribution control program further enables the computer to obtain distribution information corresponding to a channel designated by a user from a channel management table for managing correspondence between a channel and distribution information, and the computer adjusts the distribution schedule using the obtained distribution information.

9. The storage medium according to claim 1, wherein the distribution control program further enables the computer to notify a user of a difference in distribution information between before and after adjustment as compensation information if distribution information designated by the user is modified due to the adjustment of the distribution schedule.

10. A propagation signal which propagates a distribution control program to a computer which distributes data to one or more devices, the distribution control program enabling the computer to perform:
checking a distribution method of given distribution data; and
modifying distribution information of at least one of the given distribution data and scheduled distribution data depending on a type of the distribution method, and adjusting a distribution schedule.

11. A distribution control method for distributing data from a specific device to one or more other devices, comprising:
checking a distribution method of given distribution data; and
modifying distribution information of at least one of the given distribution data and scheduled distribution data depending on a type of the distribution method, and adjusting a distribution schedule.

12. A distribution system for distributing data to one or more devices, comprising:
a distribution information processing unit modifying distribution information of at least one of the given distribution data and scheduled distribution data depending on a type of the distribution method, and adjusting a distribution schedule; and
a communications control unit distributing a plurality of pieces of distribution data according to an adjusted distribution schedule.
